(19) United States
(12) Patent Application Publication
(10) Pub. No.: US 2024/0251805 A1
(43) Pub. Date: Aug. 1, 2024

(54) APPARATUS AND METHOD FOR MECHANICAL MIXING OF MEAT PRODUCTS

(71) Applicant: Eberhardt GmbH, Lichtenau (DE)

(72) Inventor: Kevin Eberhardt, Sachsen b. Ansbach (DE)

(21) Appl. No.: 18/418,492

(22) Filed: Jan. 22, 2024

(30) Foreign Application Priority Data
Jan. 31, 2023 (DE) 102023102322.5

(51) Int. Cl. A22C 5/00; B01F 27/091; B01F 27/86; B01F 29/87; B01F 35/221; B01F 35/32

(52) U.S. Cl. CPC A22C 5/00; B01F 27/091; B01F 27/861; B01F 35/22141; B01F 35/3204; B01F 29/87; B01F 35/32151

(57) ABSTRACT

An apparatus for producing protein breakdown on meat material is disclosed. The apparatus comprises at least one tool configured for producing protein breakdown on meat material. The tool forms a mixing chamber for meat material. The mixing chamber has opposite chamber walls rotatable relative to each other for controlling forces exerted on meat material therebetween. A method for producing protein breakdown on meat material and a meat production plant including at least one apparatus are further disclosed.

### CROSS-REFERENCE TO RELATED APPLICATIONS

This application claims priority to German Patent Application No. 10 2023 102 322.5 filed on Jan. 31, 2023, the disclosure of which is hereby incorporated by reference.

### FIELD OF THE DISCLOSURE

The invention relates to an apparatus for producing protein breakdown on meat material and to a corresponding method.

### BACKGROUND OF THE INVENTION

Conventionally, pieces of meat or shredded meat material, in particular pieces of meat intended for the production of reformed meat, are filled into a mixing drum of a tumbler so that protein breakdown is formed on the surface of the thoroughly mixed pieces of meat by slow rotation of the mixing drum. The protein breakdown forms a sticky film on the surface of the meat pieces and can be used as a natural binding strength to help the meat pieces nest together and bond without air pockets during the production of reformed meat. However, it can take hours for protein breakdown to form on the complete product when conventional tumblers are used, since their mixing drums are driven at only a few rotations per minute, for example at 30 rpm, particularly due to their size. This known mixing process is therefore very time-consuming and correspondingly energy intensive.

In addition, tumblers used for this purpose to produce a desired throughput volume of meat pieces with protein breakdown have a relatively large drum volume and therefore take up a lot of space. The large drums result in a drop height from which the meat pieces intermittently fall to the bottom of the drum to form the protein breakdown. The impact can produce protein breakdown on the meat material. However, this only results in a discontinuous application of force to the meat material, so that it is necessary to rotate the drums for hours in order to achieve protein breakdown uniformly on the entire meat material. The fact that conventional tumbler systems mainly have a single opening for filling and unloading meat material also means that the mixing process has to be interrupted when changing batches, which also contributes to the fact that the operation of so-called tumblers is very time-consuming and leads to increased energy costs.

### SUMMARY OF THE INVENTION

The instant disclosure provides an apparatus as well as a method for producing protein breakdown on meat material with an advantageous energy balance as well as an improved throughput rate. The apparatus and the method for producing protein breakdown on meat material represent a substantial innovation in throughput rate over the prior art. Advantageous further embodiments of the invention are further elucidated herein.

The invention relates to an apparatus with at least one tool for producing protein breakdown on meat material, wherein the tool forms a mixing chamber for meat material. According to the invention, the mixing chamber comprises opposite chamber walls rotatable relative to each other for controlling forces exerted on meat material located therebetween.

By means of the chamber walls of the mixing chamber, which are rotatable relative to each other, the meat material received between them can be kneaded evenly along its surface and continuously throughout the entire process duration. This is due to the fact that a continuous force input from the opposite chamber walls acts on the meat material between the chamber walls, resulting from pressing and counter-pressing forces, such that a uniform surface film of protein breakdown is formed on it within a short time. The force input onto the meat material is particularly efficient if a receiving volume formed by the mixing chamber is essentially completely filled with meat material.

In the invention, the rotatable chamber walls facing each other can themselves be used as counter-pressure tool parts with enlarged tool surfaces in order to exert forces on the meat material. This means that the sum of the forces acting on the meat material is such great within a short time that the desired protein breakdown production is achieved with a low energy input.

The meat material can be, for example, strip cut or chopped meat. Alternatively, it is conceivable that minced meat is used as the meat material, which is treated within the mixing chamber to form protein breakdown thereon. Furthermore, it would be conceivable that the mixing chamber is used to produce a homogeneous mixture of supplied minced meat and further supplied spices. The mixing chamber of the apparatus according to the invention can be used in a variety of ways as far as the type of meat material is concerned. However, the apparatus according to the invention may be used to produce protein breakdown on pieces of meat.

According to one variant of the invention, the mixing chamber has chamber walls that are rotatable coaxially relative to each other. This results in low-noise operation. Furthermore, it is thereby possible to rotate the chamber walls at high speeds, allowing a high throughput.

In some embodiments, the chamber walls are rotatable relative to each other about a common vertical rotation axis. This makes it possible for the rotatable chamber walls to function in common as vibration dampers, i.e. vibrations of one chamber wall resulting from rotation can be cancelled out by specifically controlled vibrations of the other rotating chamber wall, whereby the apparatus as a whole can be controlled with low vibration, i.e. with a high degree of running smoothness.

The apparatus, in particular the segment forming the tool thereon, can be configured in particular in the form of a column. This favors an overall slim design, i.e. one with reduced installation space. The apparatus can therefore be excellently integrated within already existing production facilities as a retrofit set.

An advantageous variant provides that the apparatus has a housing which surrounds the tool. This avoids interference with the rotatable masses of the tool. The housing can form ventilation holes at least in some places for dissipating drive heat.

It would be conceivable that a temperature-controllable receiving chamber is created inside the housing for the tool in order to control a temperature of the meat material processed by means of the tool. A cooling unit used for this purpose may be dynamically controlled as a function of a detected temperature of at least one of the two chamber walls.

According to one embodiment of the invention, the chamber walls are rotatable at different rotational speeds and/or in opposite rotational directions to each other. This allows the force input on the meat material inside the mixing chamber to be controlled in a targeted manner. In particular, the chamber walls can be rotated independently of each other. It would therefore also be conceivable for only one of the two chamber walls to rotate, at least temporarily. In this function, the tool can be used in particular for mixing a supplied meat mass due to the reduced force input, for example to mix prefabricated minced meat with spices.

One variant provides that at least one of the two chamber walls is rotatable at a rotational speed of up to 300 rotations per minute, in some embodiments at least one of the two chamber walls is rotatable at a rotational speed of up to 500 rotations per minute. The respective rotational speeds of the chamber walls may be continuously adjusted. In particular, the rotational speeds of the two chamber walls can be synchronized.

It would be conceivable that at the beginning of a mixing process, i.e. with a new batch of meat material with which the mixing chamber is filled, the chamber walls can only be controlled at a predetermined, limited rotational speed in order to gently mix the meat material arriving first inside the mixing chamber. This ensures that the meat material introduced at the beginning of the mixing chamber can first settle towards the bottom of the mixing chamber.

It would be particularly useful in this context to provide a filling level detection system designed to cancel the speed limitation when a predetermined filling level of meat material can be detected in the mixing chamber. This fill level detection could thus easily detect at which point in time the mixing chamber is sufficiently filled with meat material so that the force input emanating from the chamber walls onto the meat material, in particular the resulting forces transmitted from the pieces of meat to each other, can have a maximum effect.

In certain embodiments, the apparatus for driving the chamber walls has two separate electric motors. It is particularly advantageous if both electric motors are arranged one above the other. A slim design would be possible in particular by superimposing their respective drive axes, in particular both coinciding with the common vertical rotation axis of the chamber walls. This permits a columnar design of the apparatus with reduced installation space, which can thus be easily integrated into an existing production facility while requiring little space.

It would be convenient if the tool were arranged between the two electric motors. This favors a particularly robust design of the apparatus, since it results in an even weight distribution of components used thereon. A high degree of stability of the apparatus can be achieved in particular by the lower electric motor being designed to drive the externally formed chamber wall and the upper electric motor being designed to drive the internally formed chamber wall.

It would be conceivable for at least one of the two electric motors to be mounted laterally next to the chamber wall it drives. In this arrangement, a belt drive could be used to transmit the drive torque from the electric motor to the chamber wall mounted laterally next to it. This design, which is not configured one above the other but side by side, feeds a reduced overall height.

One variant provides that the mixing chamber has at least partially conical and/or cylindrical chamber walls which are rotatable relative to each other. Cylindrical chamber walls facing each other form a mixing chamber with an annular gap-shaped volume for the meat material, thus offering the advantage of a slim design. Conical chamber walls facing each other form a mixing chamber with a conical volume for receiving the meat material and can therefore increase the capacity compared to a cylindrical design. In addition, with the conical design, meat material can be quickly fed out of the mixing chamber at an outlet opening formed in the area of the smallest cross-section, which can further accelerate the process for forming protein breakdown.

It is advantageous if at least one of the chamber walls rotatable relative to each other has at least one baffle for the meat material. Such a baffle can take the form of a recess, an elevation, in particular a helical elevation, for example a screw shape, in order to exert an increased force input on the meat material. The baffle can ensure that the protein breakdown produced inside the mixing chamber is distributed evenly over the meat material. Conceivably, at least some areas of at least one of the two chamber walls may have a surface provided with a serrated profile.

A particularly advantageous variant provides that at least one of the chamber walls rotatable relative to each other forms a helical surface at least in some areas. It is conceivable that the inner chamber wall is formed by a body in the form of a screw. The outer chamber wall can be formed by a hollow body with a spiral shape along its inner surface. This allows to roll the meat material received in between even better, thus enabling forces to act on the meat material from all sides. This results in even faster protein breakdown production on the meat material. In addition, such surfaces are very easy to clean.

According to one embodiment, at least one of the two chamber walls is formed by an exchangeable tool part that can be easily replaced by another tool part. This other tool part can have a different surface finish. In some embodiments, the entire tool can be removed, in particular without tools, for cleaning processes.

It is conceivable that the apparatus comprises a feeding device for feeding meat material into the mixing chamber and/or a receptacle for meat material, from which the meat material can be fed into the mixing chamber. The feeding device can have a feeding tube which, in particular, connects the receptacle to the mixing chamber. According to a particularly simple design, the feeding tube alone forms the feeding device, i.e. no separate receptacle is used for storing meat material, but the meat material enters the mixing chamber directly via the feeding tube.

It is advantageous if the receptacle for the meat material is positioned above the mixing chamber. This has the effect that a weight force generated by the receptacle acts on the apparatus from above, which produces a vibration-damping effect on the rotatable masses of the mixing chamber positioned below, resulting in an overall increase in the running smoothness of the apparatus.

One variant provides for the receptacle to be positioned directly above the mixing chamber, i.e., meat material can be fed directly from the receptacle into the mixing chamber. In this variant, an electric motor for driving the mixing chamber can be positioned at the side of the mixing chamber. In this way, despite the use of a receptacle for storing meat material, a reduced overall height of the apparatus is achieved and the meat material stored in the receptacle can be fed directly out of the receptacle into the mixing chamber, i.e. without an intermediate tube connection.

In particular, the mixing chamber can be supplied with meat material directly from the above positioned bottom of the receptacle through an opening in the form of an annular gap. Due to the weight of the meat material from above, thereby, as the mixed meat material leaves the mixing chamber, new meat material can be continuously pressed from above out of the receptacle into the mixing chamber connected below. To ensure that the meat material in the receptacle moves in a targeted manner towards the annular opening formed in its base, the receptacle can have a shape tapering towards the mixing chamber, in particular in the form of a funnel adjoining the latter, so that the meat material from the receptacle can be fed in a targeted manner to the mixing chamber.

Conceivably, the receptacle may have double-walled boundary walls that enclose an air gap therebetween to better maintain a temperature of the meat material stored in the receptacle. The boundary walls may be configured to be temperature controlled to cool the meat material received therein.

Conceivably, a plurality of tools with rotatable chamber walls could be connected to the receptacle to receive meat material therefrom. These tools can be supplied with meat material from the receptacle in parallel, resulting in an increased flow rate.

According to one embodiment, the mixing chamber comprises both a feeding opening for meat material and a separately designed discharge opening for meat material with protein breakdown. These two openings enable an uninterrupted, i.e. continuous, mixing process, since meat material to be treated can be fed to the mixing chamber through the feeding opening exactly when meat material with protein breakdown treated inside the mixing chamber leaves the mixing chamber through the discharge opening. This means that downtimes of the apparatus can be reduced.

Both the feeding of meat material and the discharge of meat material with protein breakdown can be controlled by the mixing process taking place in between within the mixing chamber. In this process, a volumetric flow rate can be varied by controlling the respective rotational speeds of the chamber walls. In particular, the apparatus can thus be easily integrated into a dynamic open-loop or closed-loop control process which is designed to automatically coordinate the feed of untreated meat material under speed control as a function of a requested filling quantity of meat material with protein breakdown.

In particular, it would be conceivable that a rotation speed reversal of at least one of the rotatable chamber walls would result in the discharge of treated meat material from the discharge opening of the mixing chamber being preventable solely as a result thereof, i.e. as a result thereof the meat material circulated in the mixing chamber can be automatically retained therein without the need for a separate closure mechanism for the discharge opening.

A particularly advantageous design results from the fact that the tool has a rotatable drum and a rotating body which is mounted coaxially therein and rotatable independently of the drum, wherein the drum and the rotating body form the chamber walls of the mixing chamber which are rotatable relative to each other. The drum forms the outer tool part, i.e. the outer chamber wall, and the rotating body forms the inner tool part, i.e. the inner chamber wall of the mixing chamber formed therebetween.

In particular embodiments, the drum forms a cylindrical or conical drum wall facing the rotatable body and the rotatable body forms a cylindrical or conical rotating body wall facing the drum, wherein the drum wall and the rotating body wall form the chamber walls of the mixing chamber rotatable relative to each other.

A high force impact on the meat material is possible above all if the gap formed between the drum and the rotating body has a gap width of less than 10 cm, or less than 5 cm. This narrow gap dimension of the mixing chamber can prevent meat material from being left untreated without force impact during the mixing process inside the mixing chamber.

One variant provides that the apparatus has a discharge device connected to the mixing chamber for meat material with protein breakdown treated by the tool. The discharge device can have a screw conveyor which is designed to transport meat material with protein breakdown away from the apparatus in a predetermined conveying direction. The screw conveyor can be rotatably mounted within a transport tube, which is connected to the discharge opening of the mixing chamber. This allows the meat material produced with protein breakdown to be transported to a predetermined discharge location.

It would be conceivable for the transport tube, or at least part of it, to be designed such that it can be swiveled and/or telescoped in order to be able to deliver meat material with protein breakdown conveyed therein to different delivery points.

The discharge device may comprise a separator for separating excess protein breakdown. In particular, the transport tube may have the separator formed thereon, for example, as a section perforated at the bottom of the tube, along which excess protein breakdown can be separated from meat material conveyed there above.

In certain embodiments, all surfaces of the apparatus that come into contact with the meat material are formed by components made of stainless steel. Some surfaces can even be highly polished in order to better prevent the deposition of impurities on them.

One variant provides that the discharge device has at least one rotatable cutting tool for cutting the meat material with protein breakdown or mixed material conveyed out of the mixing chamber into smaller pieces. This would also make it possible to produce a pulpy homogeneous meat mass with protein breakdown from the meat pieces leaving the mixing chamber.

The cutting tool can comprise at least one rotatable cutting blade and/or is attached as a removable attachment kit, in particular at the outlet of the discharge device.

According to an advantageous variant, the production of protein breakdown on the meat material can be increased by generating a vacuum within the mixing chamber. For this purpose, the apparatus can have at least one vacuum pump connected to the mixing chamber. In this advantageous variant, the mixing chamber is used as a vacuum chamber, thus fulfilling a dual function in technical terms. The vacuum applied can supplement the pressing and counter-pressing forces exerted on the meat material in the mixing chamber by means of rotation in such a way that protein breakdown can be formed on it even more effectively. Above all, the vacuum promotes the absorption of a (seasoning) liquid, for example brine, into the meat material processed in the mixing chamber.

It is conceivable that one of the electric motors on the apparatus that can be used to rotate the chamber walls can also be used to drive the vacuum pump. In this embodiment, the application of the vacuum could be coupled to the rotation of the chamber wall, i.e. generated automatically in the mixing chamber when the chamber wall rotates. Alternatively, the vacuum pump can also have its own drive, in particular its own electric motor.

One embodiment of the invention relates to a reformed meat production plant comprising at least one apparatus according to the invention and a filling station at which the meat material with protein breakdown produced by means of the apparatus can be filled, in particular, into at least one mold provided at the filling station for the production of reformed meat. The protein breakdown on the pieces of meat ensures that the pieces of meat received in the mold are bonded to one another by a smoking or cooking process, so that a coherent body of meat is produced according to the mold, which can be excellently sliced.

According to one variant, the filling station comprises a vacuumizer designed to pack the meat material with protein breakdown leaving the apparatus in portions under vacuum seal.

In particular, it is conceivable that several apparatuses according to the invention are connected in series next to one another to the filling station via the discharge device, wherein the discharge device is designed to receive meat material with protein breakdown from the respective apparatuses according to the invention and to transport it on to the filling station. The meat material arriving there can then be filled into molds provided for producing reformed meat or, alternatively, fed to a vacuum packaging process.

In particular, molds fed one behind the other at the filling station can be filled with meat material and transported from there away in a desired direction. For the provision of empty molds, the reformed meat production plant could have an underpass or a low-floor conveyor. This can run at least in sections within a machine frame of the reformed meat production plant. Such a reformed meat production plant can be integrated as a production line in a confined space. In particular, the reformed meat production plant has a rectilinear structure. It would thus be conceivable for several reformed meat production plants to operate side by side as parallel production lines.

Furthermore, the invention relates to a method for producing protein breakdown on meat material, wherein the meat material, in particular pieces of meat or minced meat, is fed to at least one mixing chamber. The method according to the invention provides that opposite chamber walls of the mixing chamber can be rotated relative to each other for exerting mechanical forces on the meat material located therebetween. This makes it possible, within a short time, to control a mechanical force input through the chamber walls onto the meat material located therebetween in such a way that a desired mass of protein breakdown can be produced thereon, which is advantageous as a binding strength for a subsequent processing process, in particular for the production of reformed meat.

In particular, the chamber walls can be rotated at least temporarily in opposite rotational directions and/or about a common vertical rotation axis to produce meat material with protein breakdown therebetween.

According to one variant, a vacuum is applied to the mixing chamber, which allows the mechanical forces generated by rotation to be increased on the meat material received in the mixing chamber, so that protein breakdown can be produced within a shorter time.

In addition, the invention relates to the use of a mixing chamber having opposite chamber walls rotatable relative to each other for exerting a controlled mechanical force input on meat material therebetween to produce protein breakdown thereon.

In particular embodiments the mixing chamber is used to apply pressing and counter-pressing forces to meat pieces enclosed therein and filling the chamber volume by rotating at least one of the chamber walls so that protein breakdown is formed from a superficial cell structure of the enclosed meat pieces. Optionally, the mixing chamber can also be used as a vacuum chamber by applying a vacuum between the chamber walls.

It is conceivable that several mixing chambers arranged in series in the direction of production are used to produce meat material with protein breakdown, which is filled using a discharge device at a filling station located downstream in the direction of production.

### BRIEF DESCRIPTION OF DRAWINGS

The invention is explained in more detail by way of example with reference to the following figures. It shows:

FIG. 1 shows a side view of the apparatus according to the invention in a sectional view,

FIG. 2 shows a perspective view of the apparatus shown in FIG. 1,

FIG. 3 shows an embodiment of the apparatus according to the invention with a receptacle,

FIG. 4A shows a schematic representation of an apparatus according to the invention with cylindrical chamber walls,

FIG. 4B shows a schematic representation of an apparatus according to the invention with conical chamber walls, and

FIG. 5 shows a reformed meat production plant with several apparatuses according to the invention.

Identical technical components are each given the same reference signs in the figures.

### DETAILED DESCRIPTION

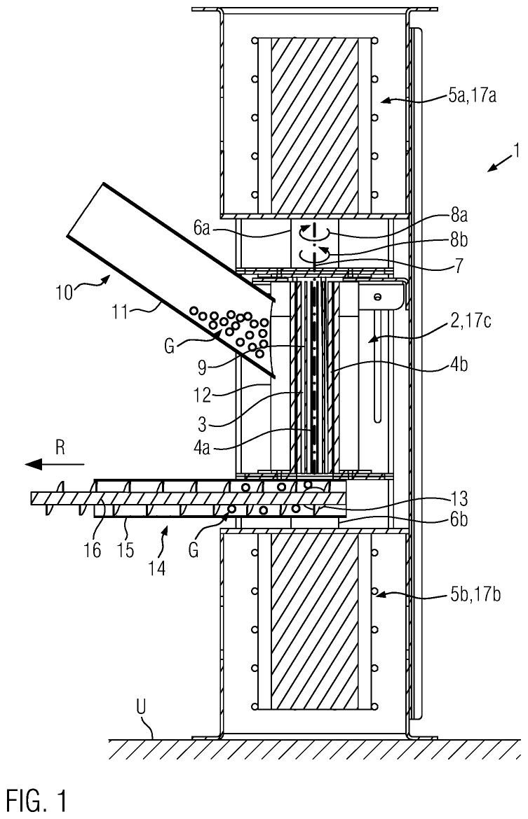

FIG. 1 shows an apparatus 1 for producing protein breakdown on meat material G. In FIG. 1, the meat material G is formed of pieces of meat, for example shredded pork. The apparatus 1 has a tool 2 which forms a mixing chamber 3 for the meat material G. The tool 2 of FIG. 1 has a cylindrical structure.

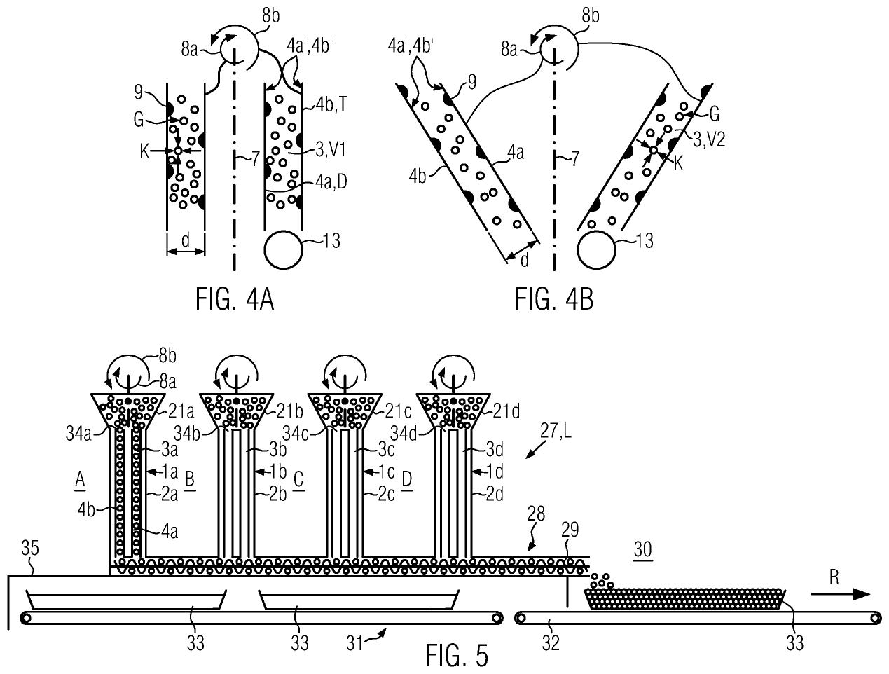

The mixing chamber 3 of FIG. 1 has opposite chamber walls 4a, 4b which are rotatable relative to each other for controlling pressing and counter-pressing forces K exerted on the meat material G located therebetween (see FIGS. 4A and 4B). According to FIG. 1, the chamber walls 4a, 4b of the mixing chamber 3 are cylindrical. As a result, the tool 2 has a cylindrical design.

The chamber wall 4a shown on the inside in FIG. 1 can be driven by means of an electric motor 5a. A further electric motor 5b is provided for the chamber wall 4b shown on the outside in FIG. 1. FIG. 1 shows that the tool 2 including the mixing chamber 3 formed with it is mounted between the two electric motors 5a, 5b. The two electric motors 5a, 5b have respective drive axes 6a, 6b which are rotatable together with the chamber walls 4a, 4b about a common vertical rotation axis 7. The apparatus 1 of FIG. 1 thus has a slim design, is overall in the form of a column, and can be easily set up in a production facility in this design.

FIG. 1 indicates that the respective chamber walls 4a, 4b of the tool 2 are rotatable in opposite directions 8a, 8b about the vertical rotation axis 7. A baffle 9 is shown schematically between the two chamber walls 4a, 4b (see also FIGS. 4A and 4B), which is formed on the inner chamber wall 4a and/or on the outer chamber wall 4b. The baffle 9 is, for example, in the form of a spiral, so that the chamber wall 4a or the chamber wall 4b forms a helical surface with it. It is conceivable that both chamber walls 4a, 4b have a helical baffle 9.

The apparatus 1 shown in FIG. 1 further comprises a feeding device 10. According to FIG. 1, the feeding device 10 is a feed tube 11 for feeding meat material G into the mixing chamber 3. The feed tube 11 opens into a housing 12 for the tool 2 and feeds the meat material G into the mixing chamber 3, for example through a feeding opening of the outer chamber wall 4b which is not shown. The housing 12 is substantially cylindrical and forms a receptacle for the tool 2.

In addition to the feeding opening not shown in FIG. 1, the mixing chamber 3 has a separately formed discharge opening 13 for meat material G with protein breakdown. This is formed at the lower outlet of the tool 2. According to FIG. 1, the discharge opening 13 feeds the meat material G formed with protein breakdown into a discharge device 14. The discharge device 14 comprises a transport tube 15 and a screw 16 arranged therein as conveying means for further transporting the meat material G entering the tube 15 through the discharge opening 13 in the conveying direction R.

Meat material G poured into the feed tube 11 of the feeding device 10 passes through the feed tube 11, which is formed as a chute, into the mixing chamber 3. By causing at least one of the chamber walls 4a, 4b to rotate about the rotation axis 7, the meat material G received between the chamber walls 4a, 4b can be subjected to pressing and counter-pressing forces K in such a way that protein breakdown forms on the surface of the meat pieces, which serves as a binding strength for downstream processes, for example as a binding strength for the production of reformed meat.

By rotating in opposite directions, but also as the case may be by rotating in the same direction at different rotational speeds, the two chamber walls 4a, 4b can be controlled in such a way that the meat material G located between them passes through the discharge opening 13 into the discharge device 14 in a desired volumetric flow, wherein the screw 16 rotating therein transports the meat material G away in the conveying direction R.

The apparatus 1 shown in FIG. 1 is a mini-tumbler with speed-controllable chamber walls 4a, 4b due to its columnar shape. The columnar design shown in FIG. 1 can be easily mounted on a base U, for example, it is screwed to it.

The apparatus 1 of FIG. 1 has three module segments in vertical alignment, namely an upper drive module 17a, a lower drive module 17b and an intermediate tool module 17c together with the feeding device 10. The modules arranged one above the other in the vertical direction, i.e. the upper drive module 17a, the lower drive module 17b and the intermediate tool module 17c, when assembled one above the other form a slim column with masses rotating along the rotation axis 7, so that an overall robust, vibration-insensitive construction is produced.

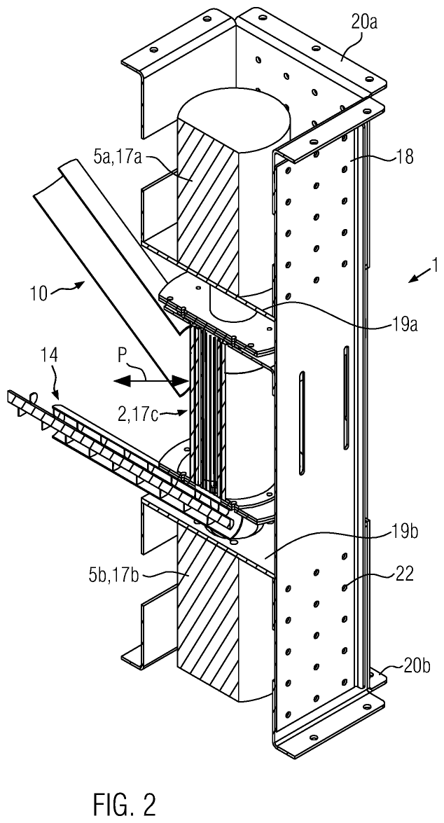

FIG. 2 shows the apparatus 1 shown in FIG. 1 in perspective sectional view. The apparatus 1 has a casing 18 which encloses the electric motors 5a, 5b and the tool 2 arranged between them. The module segments 17a, 17b, 17c arranged one above the other are separated from each other by partitions 19a, 19b formed in the casing 18, resulting in a particularly stable structure for the apparatus 1. This segmented structure also offers the advantage that the tool 2 located between the electric motors 5a, 5b can be easily removed without having to remove the electric motors 5a, 5b. This removal function for the tool 2 is schematically represented by the double arrow P.

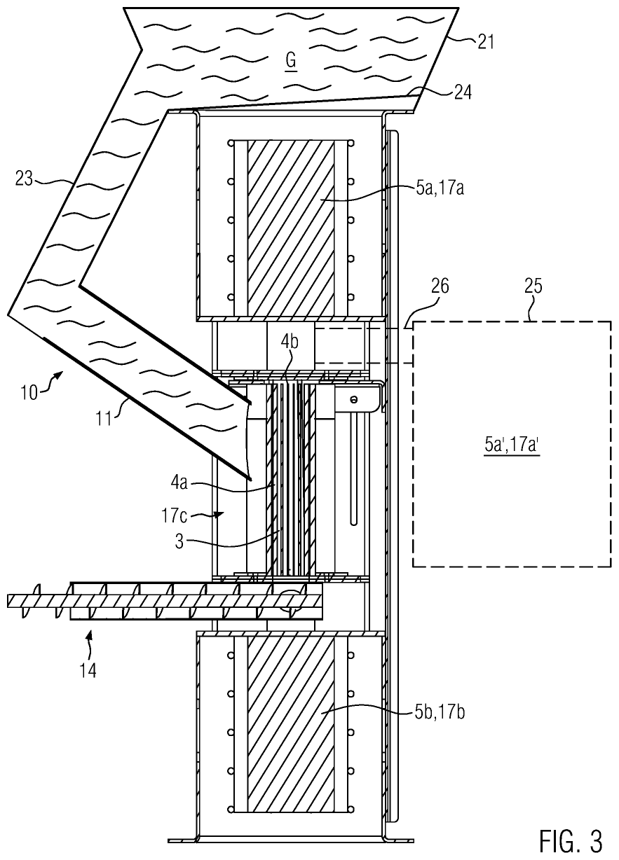

Furthermore, FIG. 2 shows that the casing 18 is formed with lower and upper mounting brackets 20a, 20b. The lower mounting brackets 20b can be used for screwing the apparatus 1 to the substrate U. The upper mounting brackets 20a can be used to mount a receptacle 21 (see FIG. 3). To dissipate motor heat, ventilation holes 22 are associated with the respective electric motors 5a, 5b in the casing 18 shown.

FIG. 3 shows the apparatus 1 of FIGS. 1 and 2 with a receptacle 21 mounted thereon. The receptacle 21 is used for storing meat material G and is connected to the mixing chamber 3 via a tube connection 23, which is joined to the feed tube 11. The feed tube 11 and the tube connection 23 may also have an integral construction.

The meat material G stored in the receptacle 21 slides automatically over an inclined bottom 24 into the tube connection 23 and further over the feed tube 11 into the mixing chamber 3, where it is treated with a mechanical force input by rotating chamber walls 4a, 4b to form protein breakdown thereon.

FIG. 3 also indicates in schematic representation that the upper electric motor 5a, i.e. the upper drive module 17a, can be displaced into a dashed zone 25. An electric motor 5a or drive module 17a positioned in this zone 25 can transmit a rotary motion to the interior chamber wall 4a by means of a V-belt 26 to cause it to rotate. This alternative configuration results in a lower overall height of the apparatus 1. Should this alternative configuration additionally have a receptacle 21 as shown in FIG. 3, this can be mounted directly on the tool module 17c. This variant would have the advantage that the meat material G could enter the mixing chamber 3 directly from the receptacle 21 through an opening formed in the bottom 24, i.e. without a separate feeding device 10. With this direct meat material feed, it would be advantageous if the receptacle 21 were in the form of a funnel, in the base of which an annular opening is formed. This principle of direct meat product feeding is shown schematically in FIG. 5.

The apparatuses 1 described above in connection with FIGS. 1 to 3 form a mini-tumbler which, as shown in FIG. 1, is of simple design with the feeding device 10, i.e. without receptacle 21, or of the variants shown in FIG. 3, i.e. with indirect or direct meat product feed from the receptacle 21. All variants have a compact design and can be installed without difficulty in a confined space.

The operation of a cylindrical mixing chamber 3 is shown schematically in FIG. 4A. A conical mixing chamber 3 is described in connection with FIG. 4B.

FIG. 4A shows cylindrical chamber walls 4a, 4b rotatable about a common vertical rotation axis 7 and facing helical surfaces 4a′, 4b′. The chamber wall 4a is formed by a drum T. The chamber wall 4b is formed by a rotating body D received in the drum T.

FIG. 4A shows that the chamber walls 4a, 4b are rotatable in opposite rotational directions 8a, 8b about the rotation axis 7. Meat material G located between them is mechanically rolled with pressing and counter-pressing forces K in order to produce protein breakdown thereon, wherein meat material G treated between the chamber walls 4a, 4b by means of force input leaves the tool 2 through the discharge opening 13 shown schematically, and in particular can be fed to the discharge device 14 shown in FIG. 1.

According to FIG. 4A, the mixing chamber 3 has a volume V1 formed between the cylindrical chamber walls 4a, 4b, which forms a capacity of the mixing chamber 3. The volume V1 is defined, among other things, by a gap width d. The baffles 9 used within the volume V1 on the chamber walls 4a, 4b ensure that the meat material G filled in between is mixed under the action of pressing and counter-pressing forces K so that it forms protein breakdown on its surface.

FIG. 4B shows a mixing chamber 3 with a volume V2 formed between conical chamber walls 4a, 4b. These conical chamber walls 4a, 4b also have helical surfaces 4a′, 4b′ facing each other. The volume V2 has a larger capacity than the volume V1 shown in FIG. 4A.

The previously described apparatuses 1 can be used either individually or repeatedly at a production site.

FIG. 5 shows a reformed meat production plant 27 having a plurality of apparatuses 1a to 1d operating in series in the direction of production R, each configured to produce meat material G with protein breakdown and together forming a production line L. The number of apparatuses 1a to 1d which together form the production line L may vary as desired.

According to FIG. 5, four apparatuses 1a, 1b, 1c, 1d arranged one behind the other in production direction R are connected to a common discharge device 28. The common discharge device 28 has a rotatable screw conveyor 29 mounted along the production direction R, by means of which the meat material G treated from the apparatuses 1a to 1d by means of force input K can be conveyed to a filling station 30. Furthermore, FIG. 5 shows that by means of a low-floor conveyor device 31, which has conveyor belts 31, 32, molds 33 are successively made available at the filling station 30 so that they can be filled with meat material G from the discharge device 28.

According to FIG. 5, the respective receptacles 21a to 21d are mounted directly on the respective tools 2a to 2d for direct meat material feeding, wherein meat material G can be fed from the receptacles 21a to 21d through respective annular gap-shaped feeding openings 34a to 34d to the respective mixing chambers 3a to 3d. The respective receptacles 21a to 21d have a downwardly tapering funnel shape so that the meat material G stored therein can be selectively fed through the respective annular gap-shaped feeding openings 34a to 34d to the respective mixing chambers 3a to 3d.

In FIG. 5, the respective apparatuses 1a to 1d positioned at positions A to D can be operated one after the other. In FIG. 5, for example, the apparatus 1a positioned at the first point A in production direction R starts to produce meat material G with protein breakdown. As soon as the receptacle 21a is empty, the next apparatus 1b at position B can start to produce meat material G with protein breakdown, so that the empty receptacle 21a can be filled without interrupting the meat material supply at the filling station 30.

The low-floor conveyor 31 shown in FIG. 5 can be integrated within a machine frame 35 of the reformed meat production plant 27. Molds 33 filled with meat material G can be fed in the direction of production R to a downstream jerking or cooking station for temperature treatment of the meat material G accommodated in the molds 33, for example for the production of cooked ham.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. An apparatus for producing protein breakdown on meat material, the apparatus comprising at least one tool configured for producing protein breakdown on meat material, wherein the tool forms a mixing chamber for meat material, and wherein the mixing chamber has opposite chamber walls rotatable relative to each other for controlling forces exerted on meat material located therebetween.

2. The apparatus according to claim 1, wherein the mixing chamber has chamber walls rotatable coaxially relative to each other.

3. The apparatus according to claim 2, wherein the chamber walls are rotatable relative to each other about a common vertical rotation axis.

4. The apparatus according to claim 1, wherein the chamber walls are rotatable at different rotational speeds and/or in opposite rotational directions.

5. The apparatus according to claim 1, wherein the apparatus comprises two separate electric motors for driving the chamber walls.

6. The apparatus according to claim 1, wherein the mixing chamber has at least partially conical and/or cylindrical chamber walls which are rotatable relative to each other.

7. The apparatus according to claim 1, wherein at least one of the chamber walls rotatable relative to each other has a baffle for the meat material.

8. The apparatus according to claim 1, wherein the chamber walls rotatable relative to each other have helical surfaces facing each other at least in some areas.

9. The apparatus according to claim 1, wherein the apparatus comprises a feeding device for feeding meat material into the mixing chamber and/or a receptacle for meat material, from which the meat material Can be fed into the mixing chamber.

10. The apparatus according to claim 1, wherein the mixing chamber comprises both a feeding opening for meat material and a discharge opening, formed separately therefrom, for meat material with protein breakdown.

11. The apparatus according to claim 1, wherein the tool has a rotatable drum and a rotating body mounted coaxially therein and rotatable independently of the drum, wherein the drum and the rotating body form the chamber walls of the mixing chamber which are rotatable relative to each other.

12. The apparatus according to claim 11, wherein the drum forms a cylindrical or conical drum wall facing the rotating body and the rotating body forms a cylindrical or conical rotating body wall facing the drum, wherein the drum wall and the rotating body wall form the other rotatable chamber walls of the mixing chamber.

13. The apparatus according to claim 1, wherein the apparatus has a discharge device connected to the mixing chamber for meat material treated by the tool.

14. The apparatus according to claim 1, wherein a vacuum can be generated within the mixing chamber.

15. A meat production plant comprising:
at least one apparatus according to claim 1; and
a filling station at which pieces of the meat material with protein breakdown produced by means of the at least one apparatus can be filled into at least one mold provided at the filling station or can be portioned by a vacuumizer formed thereon.

16. A method for producing protein breakdown on meat material, the method comprising feeding meat material to at least one mixing chamber, wherein opposite chamber walls of the mixing chamber are rotatable relative to each other for controlling forces exerted on meat material located therebetween.

17. The method according to claim 16, wherein the chamber walls can be rotated at least temporarily in opposite rotational directions and/or about a common vertical rotational axis.
